(19) United States
(12) Patent Application Publication
(10) Pub. No.: US 2025/0172657 A1
(43) Pub. Date: May 29, 2025

(54) UWB RADAR DEVICE FOR PROVIDING HIGH-SPEED SAMPLING AND SYSTEM INCLUDING THE SAME

(71) Applicant: ELECTRONICS AND TELECOMMUNICATIONS RESEARCH INSTITUTE, Daejeon (KR)

(72) Inventors: Min-Hyung CHO, Daejeon (KR); Yi-Gyeong KIM, Daejeon (KR); Kyung Hwan PARK, Daejeon (KR); Young-deuk JEON, Daejeon (KR)

(73) Assignee: ELECTRONICS AND TELECOMMUNICATIONS RESEARCH INSTITUTE, Daejeon (KR)

(21) Appl. No.: 18/917,661

(22) Filed: Oct. 16, 2024

(30) Foreign Application Priority Data
Nov. 29, 2023 (KR) 10-2023-0169975
May 14, 2024 (KR) 10-2024-0063260

(51) Int. Cl. G01S 7/292; G01S 7/282; G01S 13/02

(52) U.S. Cl. CPC G01S 7/2922; G01S 7/282; G01S 13/0209

(57) ABSTRACT

A radar device that detects a detection target includes a receiver that receives an echo pulse reflected from the detection target and a radar control block that controls the radar device. The receiver includes a low-noise amplifying module that amplifies the echo pulse and a high-speed sampling module that samples a receive signal generated as the low-noise amplifying module amplifies the echo pulse. The high-speed sampling module includes a comparison reference signal generation circuit that generates comparison reference signals including a first comparison reference signal and a second comparison reference signal, a first comparison circuit that compares the receive signal with the first comparison reference signal to generate a first comparison signal, and a second comparison circuit that compares the receive signal with the second comparison reference signal. The first comparison reference signal is greater in level than the second comparison reference signal.

### CROSS-REFERENCE TO RELATED APPLICATIONS

This application claims priority under 35 U.S.C. § 119 to Korean Patent Application Nos. 10-2023-0169975 filed on Nov. 29, 2023, and 10-2024-0063260 filed on May 14, 2024, in the Korean Intellectual Property Office, the disclosures of which are incorporated by reference herein in their entireties.

### BACKGROUND

Embodiments of the present disclosure described herein relate to a radar device and a system including the same, and more particularly, relate to an ultra-wideband (UWB) radar device for providing high-speed sampling and a system including the same.

An ultra-wideband (UWB) radar device may detect an object, based on transmission and reception of a very short pulse. The UWB radar device may radiate a transmit pulse, such that the transmit pulse reaches a detection target. The UWB radar device may receive an echo pulse (or a receive pulse) generated as the detection target reflects the transmit pulse and may detect the detection target based on the echo pulse (or the receive pulse).

A reception device of the UWB radar device may radiate the transmit pulse and may then deliver a delay signal corresponding to a detection distance or the like to a receiver, such that the detection target is detected in a manner which samples the receive pulse. It may not be easy to implement a circuit for sampling the receive pulse to suit a transmit pulse generation period of the UWB radar device due to a power limitation, a circuit area limitation, or the like. Thus, there is a need for a radar device conforming to the power limitation, the circuit area limitation, or the like and including a transceiver capable of providing high-speed sampling.

### SUMMARY

Embodiments of the present disclosure provide a radar device including a transceiver capable of sampling a receive pulse at a high speed.

According to an embodiment, a radar device that detects a detection target may include a receiver that receives an echo pulse reflected from the detection target and a radar control block that controls the radar device. The receiver may include a low-noise amplifying module that amplifies the echo pulse and a high-speed sampling module that samples a receive signal generated as the low-noise amplifying module amplifies the echo pulse. The high-speed sampling module may include a comparison reference signal generation circuit that generates comparison reference signals including a first comparison reference signal and a second comparison reference signal, a first comparison circuit that compares the receive signal with the first comparison reference signal to generate a first comparison signal, and a second comparison circuit that compares the receive signal with the second comparison reference signal to generate a second comparison signal. The first comparison reference signal may be greater in level than the second comparison reference signal.

In an embodiment, the radar device may further include a pulse transceiver block that includes the receiver and includes a transmitter for radiating a transmit pulse and a communication block that communicates with an external device.

In an embodiment, the pulse transceiver block may further include a delayer that generates a delay signal corresponding to the transmit pulse. The transmitter may include a pulse generation module that generates a transmit basis pulse which is the basis of the transmit pulse and a pulse amplification module that amplifies the transmit basis pulse to generate the transmit pulse.

In an embodiment, the pulse transceiver block may further include a processor that controls the transmitter and the receiver and receives data for the detection target from the receiver.

In an embodiment, the high-speed sampling module may operate in response to the delay signal. The high-speed sampling module may further include a sampling clock generation circuit that generates a clock signal in response to the delay signal and a sampling accumulating circuit that receives the clock signal and accumulates comparison signals including the first comparison signal and the second comparison signal.

In an embodiment, the comparison reference signals may be generated by converting digital data for restoring the echo pulse into an analog signal.

In an embodiment, each of the comparison reference signals may increase by a corresponding voltage level, as the corresponding digital data sequentially increases by logic 1.

In an embodiment, the first comparison reference signal may sequentially increase from a first voltage level to a maximum voltage level and the second comparison reference signal may sequentially increase from an initial voltage level to the first voltage level. The maximum voltage level may correspond to a maximum value of the digital data and the initial voltage level may correspond to a minimum value of the digital data.

In an embodiment, the comparison reference signals may further include a third comparison reference signal and a fourth comparison reference signal.

In an embodiment, the comparison reference signal generation circuit may include a first digital-to-analog conversion (DAC) circuit that generates a first analog signal corresponding to that a most significant bit of the digital data is logic 1 and the remaining bits are logic 0, a second DAC circuit that generates a second analog signal corresponding to a varying digital input which is the remaining bits except for the most significant bit of the digital data, and a summation circuit that sums the first analog signal and the second analog signal to generate a third analog signal. The varying digital input may sequentially increase by logic 1. The second analog signal may be the second comparison reference signal and the third analog signal may be the first comparison reference signal.

In an embodiment, the comparison reference signal generation circuit may include a first DAC circuit that generates a first analog signal corresponding to that a most significant bit of the digital data is logic 1 and the remaining bits are logic 0, a second DAC circuit that generates a second analog signal corresponding to a varying digital input which is the remaining bits except for the most significant bit of the digital data, a first p-type metal-oxide-semiconductor (PMOS) transistor connected between a first node connected with the first DAC circuit and a power node and having a gate node connected with a second node connected with the first node, a second PMOS transistor connected between a third node connected with the second DAC circuit and the power node and having a gate node connected with a fourth node, a third PMOS transistor connected between a fifth node and the power node and having a gate node connected with the fourth node, a fourth PMOS transistor connected between a sixth node and the power node and having a gate node connected with the third node and the fourth node, a fifth PMOS transistor connected between the sixth node and the power node and having a gate node connected with the second node, a first resistor connected between the fifth node and a ground node, and a second resistor connected between an eighth node connected with the sixth node and the ground node.

In an embodiment, the first voltage level may be an intermediate value between the initial voltage level and the maximum voltage level.

In an embodiment, the first comparison reference signal may sequentially increase from a first voltage level to a maximum voltage level, the second comparison reference signal may sequentially increase from a second voltage level lower than the first voltage level to the first voltage level, the third comparison reference signal may sequentially increase from a third voltage level lower than the second voltage level to the second voltage level, the fourth comparison reference signal may sequentially increase from an initial voltage level to the third voltage level. The maximum voltage level may correspond to a maximum value of the digital data and the initial voltage level may correspond to a minimum value of the digital data. The first voltage level, the second voltage level, and the third voltage level may be voltage levels between the initial voltage level and the maximum voltage level.

In an embodiment, a voltage level of the fifth node may be the second comparison reference signal and a voltage level of the eighth node may be the first comparison reference signal.

According to an embodiment, a radar system that detects at least one detection target may include a first radar that detects the detection target, a second radar that detects the detection target, and a system controller that controls the first radar and the second radar. The first radar may include a receiver that receives an echo pulse reflected from the detection target and including a high-speed sampling module that samples a receive signal generated based on the echo pulse and a memory block that stores the result of detecting the detection target. The high-speed sampling module may include a comparison reference signal generation circuit that generates comparison reference signals including a first comparison reference signal and a second comparison reference signal, a first comparison circuit that compares the receive signal with the first comparison reference signal to generate a first comparison signal, and a second comparison circuit that compares the receive signal with the second comparison reference signal. The first comparison reference signal may be greater in level than the second comparison reference signal.

In an embodiment, the comparison reference signals may be generated by converting digital data for restoring the echo pulse into an analog signal.

In an embodiment, the first comparison reference signal may sequentially increase from a first voltage level to a maximum voltage level and the second comparison reference signal may sequentially increase from an initial voltage level to the first voltage level. The maximum voltage level may correspond to a maximum value of the digital data and the initial voltage level may correspond to a minimum value of the digital data.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating a radar device, according to an embodiment of the present disclosure;

FIG. 2 is a block diagram illustrating a pulse transceiver block of FIG. 1, according to an embodiment of the present disclosure;

FIG. 3 is a block diagram illustrating a high-speed sampling module of FIG. 2, according to an embodiment of the present disclosure;

FIG. 4A is a graph illustrating a change in comparison voltage of FIG. 3 over time, according to an embodiment of the present disclosure;

FIG. 4B is a graph illustrating a change in comparison voltages for providing high-speed sampling over time, according to an embodiment of the present disclosure;

FIG. 5 is a block diagram illustrating in detail a high-speed sampling module of FIG. 2 or 4B, according to an embodiment of the present disclosure;

FIG. 6 is a block diagram illustrating in detail a comparison voltage generation circuit of FIG. 5, according to an embodiment of the present disclosure;

FIG. 7 is a circuit diagram illustrating in detail a comparison voltage generation circuit of FIG. 5, according to an embodiment of the present disclosure;

FIG. 8 is a graph illustrating in detail comparison voltages provided to comparison circuits, according to an embodiment of the present disclosure;

FIG. 9 is a block diagram illustrating a high-speed sampling module of FIG. 2 using comparison voltages of FIG. 8, according to an embodiment of the present disclosure;

FIG. 10 is a block diagram illustrating in detail a comparison voltage generation circuit of FIG. 9, according to an embodiment of the present disclosure; and

FIG. 11 is a block diagram illustrating a radar system, according to an embodiment of the present disclosure.

### DETAILED DESCRIPTION

Hereinafter, embodiments of the present disclosure may be described in detail and clearly to such an extent that an ordinary one in the art easily implements the present disclosure.

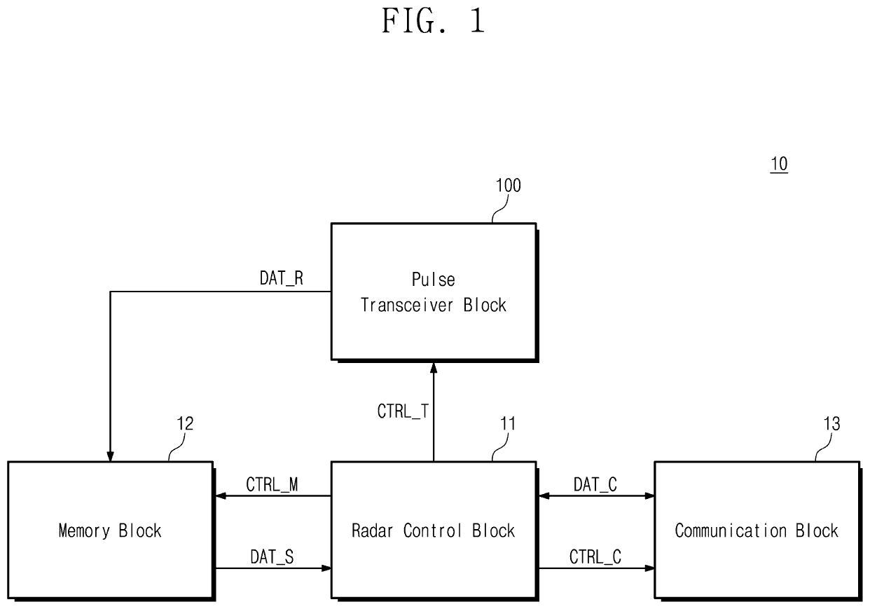

FIG. 1 is a block diagram illustrating a radar device 10, according to an embodiment of the present disclosure. Referring to FIG. 1, the radar device 10 may include a radar control block 11, a memory block 12, a communication block 13, and a pulse transceiver block 100. The radar device 10 may be a device configured to detect a target. In an embodiment, the radar device 10 may detect a detection target, based on a pulse. For example, the radar device 10 may be an ultra-wideband (UWB) radar device. Hereinafter, it is described that the radar device 10 is the UWB device, but this is illustrative. The scope of the present disclosure is not limited thereto.

The radar control block 11 may control the overall operation of the radar device 10. The radar control block 11 may control to start or end detection of the radar device 10. In an embodiment, the radar control block 11 may control the components of the radar device 10 by means of control signals. For example, the radar control block 11 may control the memory block 12 by means of a memory control signal CTRL_M and may control the pulse transceiver block 100 by means of a transmission and reception control signal CTRL_T. Likewise, the radar control block 11 may control the communication block 13 by means of a communication control signal CTRL_C.

In an embodiment, the radar control block 11 may operate in response to external control. For example, the radar control block 11 may generate the plurality of control signals CTRL_M, CTRL_T, and CTRL_C in response to a control signal of a user, which is included in communication data DAT_C. For another example, the radar control block 11 may generate the transmission and reception control signal CTRL_T, in response to a control signal of a system controller, which is included in the communication data DAT_C.

In an embodiment, the radar control block 11 may include any processor. For example, the radar control block 11 may include a central processing unit (CPU) or an application processor (AP) to perform calculation required to generate the control signals CTRL_M, CTRL_T, and CTRL_C. In an embodiment, the processor of the radar control block 11 may further an accelerator, such as a graphics processing unit (GPU) or a neural processing unit (NPU). In an embodiment, the radar control block 11 may include a volatile memory device (e.g., a static random access memory (SRAM), a dynamic RAM (DRAM), or the like) for storing data necessary for an operation of the processor.

The memory block 12 may store data necessary for an operation of the radar device 10. In an embodiment, the memory block 12 may store data required for the radar control block 11 to control the radar device 10. For example, the memory block 12 may store data necessary for the radar control block 11 to generate the transmission and reception control signal CTRL_T and may provide the radar control block 11 with the data.

The memory block 12 may store the data generated by the operation of the pulse transceiver block 100. In an embodiment, the memory block 12 may store receive data DAT_R generated by the operation of the pulse transceiver block 100. In an embodiment, the memory block 12 may include various types of memory devices to store the above-mentioned data. For example, the memory block 12 may include a volatile memory device (e.g., an SRAM, a DRAM, or the like) or a non-volatile memory device (e.g., a NAND flash memory or the like).

In an embodiment, the memory block 12 may generate and store sensing data DAT_S, based on the receive data DAT_R of the pulse transceiver block 100. For example, the memory block 12 may store the sensing data DAT_S of the detection target, which is generated by the operation of the pulse transceiver block 100. The sensing data DAT_S may include, for example, a type of the detection target, a detection time of the detection target, a detection distance of the detection target, sensitivity of a received signal, or the like. The memory block 12 may transmit the sensing data DAT_S to the radar control block 11. It is described in FIG. 1 that the memory block 12 generates the sensing data DAT_S, but the scope of the present disclosure is not limited thereto. It should be understood that an embodiment in which the pulse transceiver block 100 includes sensing data, based on the receive data DAT_R, also belongs to the scope of the present disclosure.

The communication block 13 may communicate with external devices outside the radar device 10. In an embodiment, the communication block 13 may communicate with the external devices in a wired or wireless manner. In an embodiment, the communication block 13 may include a user interface. For example, the communication block 13 may include at least one user interface capable of providing data to be transmitted to a monitor configured to show the user the detected result or operation or receiving an input via a keyboard or a mouse.

In an embodiment, the communication block 13 may operate depending on the operation of the radar control block 11. For example, the communication block 13 may operate in response to the communication control signal CTRL_C received from the radar control block 11. In an embodiment, the communication block 13 may transmit and receive data with the radar control block 11. For example, the communication block 13 may deliver control received from the user device (e.g., the keyboard or the mouse) or the external device to the radar control block 11 in the form of the communication data DAT_C. For another example, the communication block 13 may receive data to be delivered to the user or the external device, such as the sensing data DAT-S, from the radar control block 11 in the form of the communication data DAT_C.

The pulse transceiver block 100 may generate a transmit pulse used to detect the detection target. The pulse transceiver block 100 may receive an echo pulse generated by being scanned (or reflected) from the detection target. In an embodiment, the pulse transceiver block 100 may operate in response to the transmission and reception control signal CTRL_T of the radar control block 11. For example, the pulse transceiver block 100 may generate the transmit pulse, in response to the transmission and reception control signal CTRL_T, or may generate the receive data DAT_R, based on the received echo pulse.

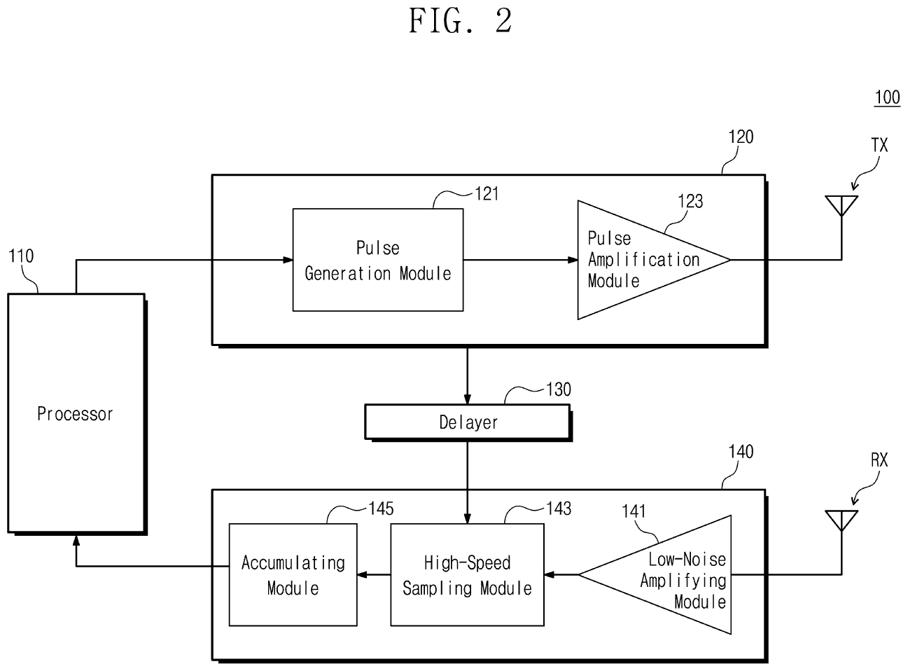

The pulse transceiver block 100 may deliver the receive data DAT_R to the memory block 12. The pulse transceiver block 100 will be described in detail below with reference to FIGS. 2 to 10. The description is given of the embodiment in which the pulse transceiver block 100 delivers the receive data DAT_R to the memory block 12, but the scope of the present disclosure is not limited thereto. In an embodiment, the pulse transceiver block 100 may generate sensing data S_DAT and may provide the memory block 12 with the sensing data S_DAT or may deliver the sensing data S_DAT to the radar control block 11.

FIG. 2 is a block diagram illustrating in detail a pulse transceiver block of FIG. 1, according to an embodiment of the present disclosure. Referring to FIG. 2, a pulse transceiver block 100 may include a processor 110, a transmitter 120, a delayer 130, a receiver 140, a transmission antenna TX, and a receive antenna RX. The pulse transceiver block unit 100 according to an embodiment of the present disclosure will be described in detail with reference to FIG. 2.

The processor 110 may control the overall operation of the pulse transceiver block 100. In an embodiment, the processor 110 may allow the transmitter 120 to generate a transmit pulse. In another embodiment, the processor 110 may receive a signal from the receiver 140 to generate receive data DAT_R. The processor 110 may include any processing unit, such as a CPU.

The processor 110 may deliver the generated receive data DAT_R to a memory block 12 of FIG. 1. When the pulse transceiver block 100 generates sensing data DAT_S, the processor 110 may generate receive data DAT_R and the sensing data DAT_S, based on the signal received from the receiver 140. In this case, the processor 110 may deliver the generated sensing data DAT_S to a memory block 12 of FIG. 1 or a radar control block 11 of FIG. 1.

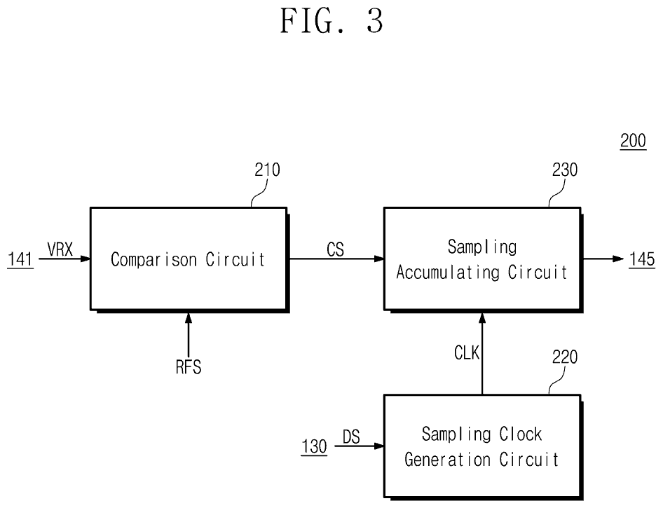

The transmitter 120 may generate and radiate a transmit pulse to a detection target. The transmitter 120 may include a pulse generation module 121 and a pulse amplification module 123. In an embodiment, the transmitter 120 may generate a transmit pulse at random intervals (e.g., at intervals of a few nano seconds (ns)). For example, the transmitter 120 may repeat with a period of a few ns to generate transmit pulses and may transmit the transmit pulses to the transmission antenna TX. in an embodiment, the transmitter 120 may select a time to repeatedly generate a transmit pulse, depending on an operation of a high-speed sampling module 143 of the receiver 140. The time for the transmitter 120 to repeatedly generate the transmit pulse will be described in detail with reference to FIG. 3.

The pulse generation module 121 may generate a transmit basis pulse which is the basis of the transmit pulse. In an embodiment, the pulse generation module 121 may generate the transmit basis pulse which is the basis of the transmit pulse, under control of the processor 110. The pulse generation module 121 may deliver the pulse which is the basis of the transmit pulse to the pulse amplification module 123. In an embodiment, the pulse generation module 121 may repeatedly (or periodically) generate the transmit basis pulse which is the basis of the transmit pulse.

The pulse amplification module 123 may amplify the pulse which is the basis of the transmit pulse to generate a transmit pulse. In an embodiment, the pulse amplification module 123 may include an amplitude amplifier. The pulse amplification module 123 may deliver the transmit pulse generated by the amplification operation to the transmission antenna TX. The transmission antenna TX may radiate the transmit pulse received from the pulse amplification module 123 to the detection target.

As the transmitter 120 generates the transmit pulse, the delayer 130 may generate a delay signal DS. The delay signal DS may be used for an operation of sampling a receive signal. In an embodiment, the delayer 130 may generate the delay signal DS corresponding to a detection distance of a radar device 10 of FIG. 1. The delayer 130 may generate and deliver the delay signal DS to the receiver 140.

The receiver 140 may receive and restore the signal reflected from the detection target. The receiver 140 may receive an echo pulse generated by being reflected from the detection target, via the receive antenna RX. The receiver 140 may include a low-noise amplifying module 141, a high-speed sampling module 143, and an accumulating module 145.

The low-noise amplifying module 141 may receive and amplify an echo pulse received by the receive antenna RX (e.g., generated as the detection target reflects the transmit pulse). In an embodiment, the signal amplified by the low-noise amplifying module 141 may be a signal including less noise. The low-noise amplifying module 141 may deliver the amplified signal to the high-speed sampling module 143.

The high-speed sampling module 143 may sample the signal in which the echo pulse is amplified by the low-noise amplifying module 141. In an embodiment, the high-speed sampling module 143 may perform a sampling operation, based on the delay signal DS. In an embodiment, the high-speed sampling module 143 may restore the echo pulse, based on digital data for restoring the receive signal. For example, the high-speed sampling module 143 may restore the receive signal (or the echo pulse), based on comparison between the echo pulse processed by the low-noise amplifying module 141 and the analog signal into which the digital data for restoring the receive signal is converted.

In an embodiment, the digital data for restoring the receive signal (or the echo pulse) may be stored in the high-speed sampling module 143 (in advance or under control of a user), may be provided from the processor 110, or may be provided from a radar control block 11 of FIG. 1. The high-speed sampling module 143 will be described in detail with reference to FIGS. 3 to 10.

The accumulating module 145 may accumulate the sampled signal. In an embodiment, the accumulating module 145 may accumulate the signals in which the echo pulse received and amplified from the high-speed sampling module 143 is sampled. The accumulating module 145 may improve a signal noise ratio (SNR) of receive data, based on the accumulation operation. The accumulating module 145 may deliver the accumulated signals to the processor 110.

FIG. 3 is a block diagram illustrating in detail a high-speed sampling module, according to an embodiment of the present disclosure. A high-speed sampling module 200 may correspond to a high-speed sampling module 143 of FIG. 2. Referring to FIG. 3, the high-speed sampling module 200 may include a comparison circuit 210, a sampling clock generation circuit 220, and a sampling accumulating circuit 230. The high-speed sampling module 200 according to an embodiment of the present disclosure will be described in detail with reference to FIG. 3. The high-speed sampling module 200 may convert a signal received from a receive antenna RX of FIG. 2 into a digital signal at a high speed and may provide a processor 110 of FIG. 2 with the digital signal.

The comparison circuit 210 may compare a receive signal VRX generated by a low-noise amplifying module 141 of FIG. 2 with a comparison reference signal RFS. The comparison circuit 210 may output the compared result as a comparison signal CS in the form of 1 bit. In an embodiment, the comparison circuit 210 may include an operational amplifier which has the receive signal VRX and the comparison reference signal RFS as inputs and has the comparison signal CS as an output. For example, when the receive signal VRX has a larger voltage than the comparison reference signal RFS, the comparison circuit 210 may generate the comparison signal CS with a value of logic 1.

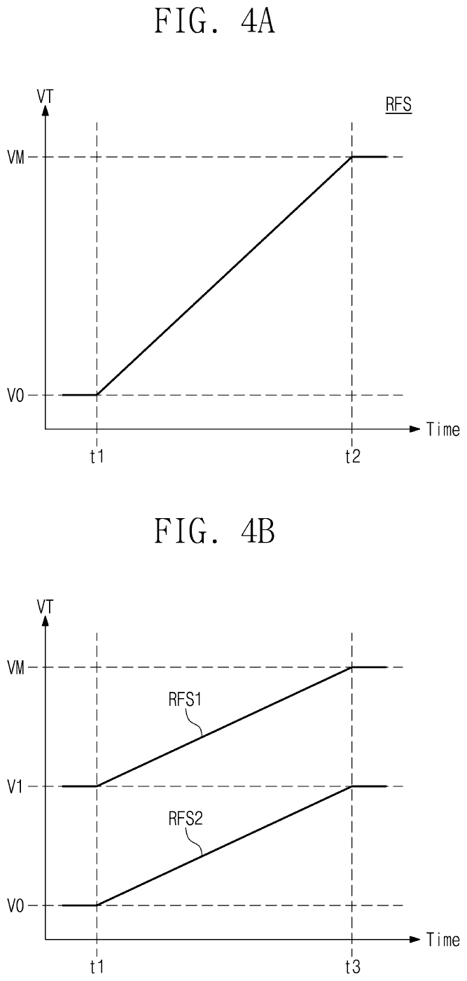

The comparison reference signal RFS may be an analog signal generated as digital data is converted. The comparison reference signal RFS may be generated based on data in a digital form of a signal for restoring the magnitude or sensitivity of the receive signal VRX. in an embodiment, the comparison reference signal RFS may be an analog signal corresponding to a reference signal in a digital form, which has any bit length. For example, the comparison reference signal RFS may be an analog signal generated as the reference signal in the digital form is converted. The comparison reference signal RFS may include a plurality of voltages. The plurality of voltages may correspond to values of a digital reference signal, respectively. The comparison reference signal RFS will be described in detail with reference to FIG. 4A.

In an embodiment, until the comparison circuit 210 compares the receive signal VRX with all the voltages in the comparison reference signal RFS, a radar device 10 of FIG. 1 may scan the same detection target. In other words, the comparison circuit 210 may compare the same receive signal VRX with all the voltages (corresponding to comparison signals in a digital form) in the comparison reference signal RFS and may deliver comparison signals CS corresponding to the results of comparing the receive signal VRX with the respective voltages to the sampling accumulating circuit 230. The comparison circuit 210 may restore a magnitude of an echo pulse received via the receive antenna RX, based on the above-mentioned operation.

The sampling clock generation circuit 220 may generate a clock signal CLK for a sampling operation. In an embodiment, the sampling clock generation circuit 220 may generate the clock signal CLK in response to a delay signal DS. In an embodiment, the period of the clock signal CLK may be the same as or shorter than a period of the repeatedly generated transmit pulse. For example, the period of the clock signal CLK generated in response to the delay signal DS by the sampling clock generation circuit 220 may be the same as a period of the transmit pulse.

The sampling accumulating circuit 230 may accumulate the comparison signal CS received from the comparison circuit 210. In an embodiment, the sampling accumulating circuit 230 may accumulate the comparison signal CS based on the clock signal CLK. For example, the sampling accumulating circuit 230 may accumulate the comparison signal CS in response to the clock signal CLK generated from the sampling clock generation circuit 220. The sampling accumulating circuit 230 may accumulate the result of comparing the comparison reference signal RFS with the receive signal VRX, in response to the clock signal CLK. The sampling accumulating circuit 230 may deliver the accumulated comparison signal CS to an accumulating module 145 of FIG. 2.

A high-speed sampling module 200 of FIG. 3 may restore a signal received via a receive antenna RX of FIG. 2, based on the operation of comparison between the comparison reference signal RFS and the receive signal VRX.

FIG. 4A is a graph illustrating a change in comparison reference signal RFS of FIG. 3 over time, according to an embodiment of the present disclosure. Referring to FIG. 4A, the vertical axis shows the voltage VT of the comparison reference signal RFS and the horizontal axis shows time. A change in the comparison reference signal RFS of FIG. 3 will be described with reference to FIG. 4A.

The comparison reference signal RFS may maintain an initial voltage level V0 before a first time point t1. In an embodiment, the first time point t1 may be a time point when a comparison operation starts and may be a time point when a high-speed sampling module 200 of FIG. 3 starts a sampling operation. In an embodiment, the comparison reference signal RFS may be voltages corresponding to an analog signal generated by converting digital data. For example, the initial voltage level V0 may be an offset voltage value and may be an analog voltage corresponding to digital data with magnitude 0. A maximum voltage level VM may be a value obtained by summing an analog voltage corresponding to a maximum magnitude of digital data to an offset voltage.

In an embodiment, digital data corresponding to the comparison reference signal RFS may be provided by a processor 110 of FIG. 2 or may be provided from a radar control block 11 of FIG. 1. In another embodiment, the digital data corresponding to the comparison reference signal RFS may correspond to data in a previously specified form (e.g., digital data with any bit length).

In an embodiment, the comparison reference signal RFS may sequentially increase from the initial voltage level V0 to the maximum voltage level VM. For example, the comparison reference signal RFS may sequentially increase by a voltage difference corresponding to a minimum interval of the digital data from the initial voltage level V0 to the maximum voltage level VM. Referring to FIG. 4A, a second time point t2 may be a time point at which the comparison reference signal RFS reaches the maximum voltage level VM. An interval between the first time t1 and the second time t2 may be a sampling time.

It is required to decrease the above-mentioned sampling time to ensure a faster operation of the high-speed sampling module 200. There is a method for shortening a period of a clock signal CLK to decrease the sampling time. However, it fails to be easy to decrease the period of the clock signal CLK due to the nature of a radar device 10 of FIG. 1, which already operates at a high speed. Thus, it is required to decrease a sampling time, depending on a method for increasing the number of times of sampling.

FIG. 4B is a graph illustrating comparison reference signals, according to an embodiment of the present disclosure. Referring to FIG. 4B, a first comparison reference signal RFS1 and a second comparison reference signal RFS2 are illustrated. In FIG. 4B, the horizontal axis may indicate time and the vertical axis may indicate the voltage VT of the comparison reference signals RFS1 and RFS2. A description will be given of a method for decreasing a sampling time with reference to FIG. 4B.

Referring to FIG. 4B, the first comparison reference signal RFS1 may have a first voltage level V1 as an initial voltage and the second comparison reference signal RFS2 may have an initial voltage level V0 as an initial voltage. In an embodiment, the first comparison reference signal RFS1 and the second comparison reference signal RFS2 may be analog signals generated by converting digital data (e.g., generated to measure sensitivity of a receive signal), respectively. In an embodiment, the initial voltage level V0 may be an offset voltage for analog conversion of digital data.

In an embodiment, the first voltage level V1 may be a voltage between a maximum voltage level VM and the initial voltage level V0. In an embodiment, the first voltage level V1 may be an intermediate voltage between the maximum voltage level VM and the initial voltage level V0. In an embodiment, an interval between the first comparison reference signal RFS1 and the second comparison reference signal RFS2 may be constant. For example, a difference between the first comparison reference signal RFS1 and the second comparison reference signal RFS2 may be an analog voltage difference corresponding to a binary magnitude of a digit of a most significant bit (MSB) of digital data.

Like a comparison reference signal RFS of FIG. 4A, the first comparison reference signal RFS1 and the second comparison reference signal RFS2 may sequentially increase. In an embodiment, the first comparison reference signal RFS1 may increase to the maximum voltage level VM and the second comparison reference signal RFS2 may increase to the first voltage level V1. For example, the first comparison reference signal RFS1 and the second comparison reference signal RFS2 may sequentially increase until a third time point t3, the first comparison reference signal RFS1 may reach the maximum voltage level VM at the third time point t3, and the second comparison reference signal RFS2 may reach the first voltage level V1 at the third time point t3. Herein, an interval between the first time point t1 and the third time point t3 may be a sampling time.

Referring to FIGS. 4A and 4B, the sampling speed may be two times in FIG. 4B. In other words, the sampling time may be shortened using the two comparison reference signals. In an embodiment, a time between the first time point t1 and the third time point t3 may be ½ times the time between the first time point t1 and the second time point t2 of FIG. 4A. In another embodiment, the time between the first time point t1 and the third time point t3 may be greater than or equal to ½ times the time between the first time point t1 and the second time point t2 of FIG. 4A and may be less than 1 time the time between the first time point t1 and the second time point t2.

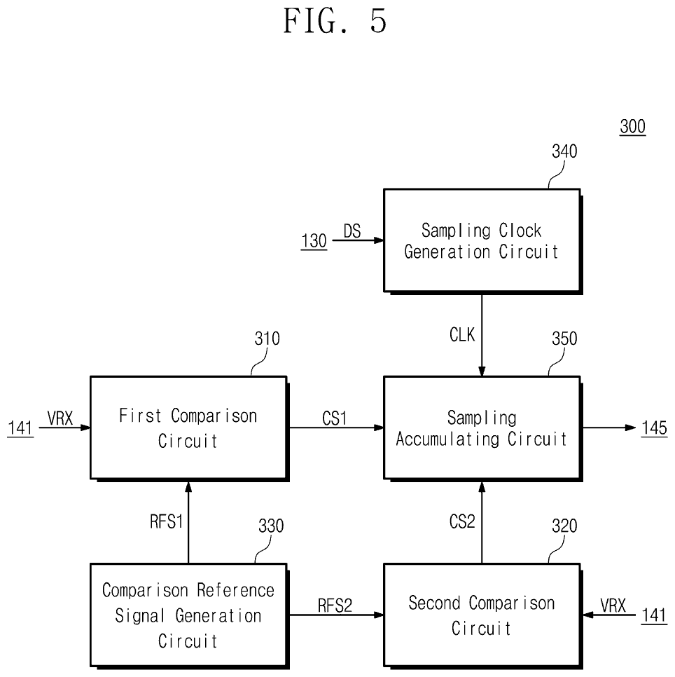

In other words, as described with reference to FIG. 4B, by using the plurality of comparison reference signals, a sampling time may be shortened, while maintaining a clock signal CLK of FIG. 3. A receive signal VRX of FIG. 3 and two reference voltages may be compared in response to one period of the clock signal CLK. A high-speed sampling module for performing sampling, according to FIG. 4B, will be described in detail with reference to FIG. 5.

FIG. 5 is a block diagram illustrating a high-speed sampling module of FIG. 2 according to an embodiment of the present disclosure. A high-speed sampling module 300 may correspond to a high-speed sampling module 143 of FIG. 2. Referring to FIG. 5, the high-speed sampling module 300 may include a first comparison circuit 310, a second comparison circuit 320, a comparison reference signal generation circuit 330, a sampling clock generation circuit 340, and a sampling accumulating circuit 350. A description will be given of the high-speed sampling module 300 for shortening a sampling time with reference to FIG. 5.

The first comparison circuit 310 may compare a receive signal VRX generated by a low-noise amplifying module 141 of FIG. 2 with a first comparison reference signal RFS1. The first communication circuit 310 may operate to be the same as or similar to a comparison circuit 210 of FIG. 3. The first comparison reference signal RFS1 may correspond to a first comparison reference signal RFS1 of FIG. 4B. The first comparison circuit 310 may output a first comparison signal CS1 in a first bit form. The first comparison circuit 310 may generate an output signal, depending on comparison between magnitudes of the receive signal VRX and the first comparison reference signal RFS1. For example, when the receive signal VRX has a larger voltage than the first comparison reference signal RFS1, the first comparison circuit 310 may output the first comparison signal CS1 with a bit value of logic 1.

The second comparison circuit 320 may compare the receive signal VRX generated by the low-noise amplifying module 141 of FIG. 2 with a second comparison reference signal RFS2. The second comparison circuit 320 may operate to be the same as or similar to the comparison circuit 210 of FIG. 3. The second comparison reference signal RFS2 may correspond to a second comparison reference signal RFS2 of FIG. 4B. The second comparison circuit 320 may output a second comparison signal CS2 in the first bit form. The second comparison circuit 320 may generate an output signal, depending on comparison between magnitudes of the receive signal VRX and the second comparison reference signal RFS2. For example, when the receive signal VRX has a larger voltage than the second comparison reference signal RFS2, the second comparison circuit 320 may output a second comparison signal CS2 with a bit value of logic 1.

In an embodiment, until each of the first comparison circuit 310 and the second comparison circuit 320 compares the receive signal VRX with all of voltages in the first comparison reference signal RFS1 and voltages in the second comparison reference signal RFS2, a radar device 10 of FIG. 1 may scan the same detection target. In other words, the first comparison circuit 310 and the second comparison circuit 320 may compare the same receive signal VRX with all the voltages (corresponding to comparison signals in a digital form) in the comparison reference signal RFS1 and RFS2 and may deliver the first comparison signals CS1 and the second comparison signals CS2 corresponding to the results of comparing the receive signal VRX with the respective voltages to the sampling accumulating circuit 350. The first comparison circuit 310 and the second comparison circuit 320 may restore a magnitude of an echo pulse received via a receive antenna RX, based on the above-mentioned operation.

The comparison reference signal generation circuit 330 may generate the comparison reference signals RFS1 and RFS2 provided to the first comparison circuit 310 and the second comparison circuit 320. In an embodiment, the comparison reference signal generation circuit 330 may convert digital data into an analog signal to generate the first comparison reference signal RFS1 and the second comparison reference signal RFS2. For example, the comparison reference signal generation circuit 330 may convert digital data to generate the first comparison reference signal RFS1 and the second comparison reference signal RFS2 of FIG. 4B.

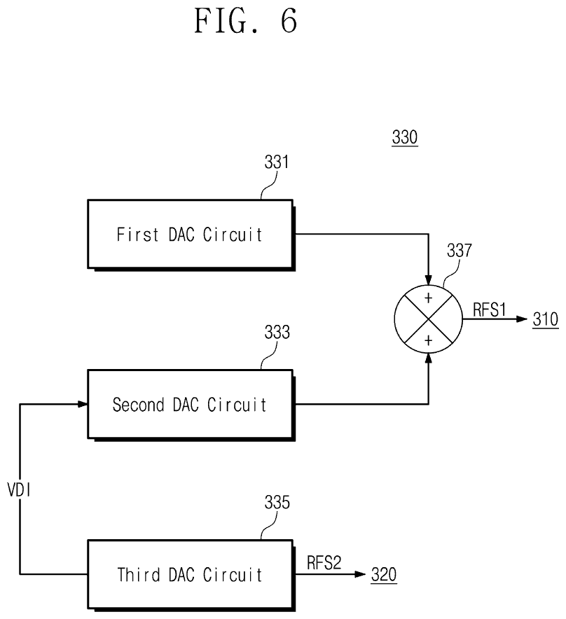

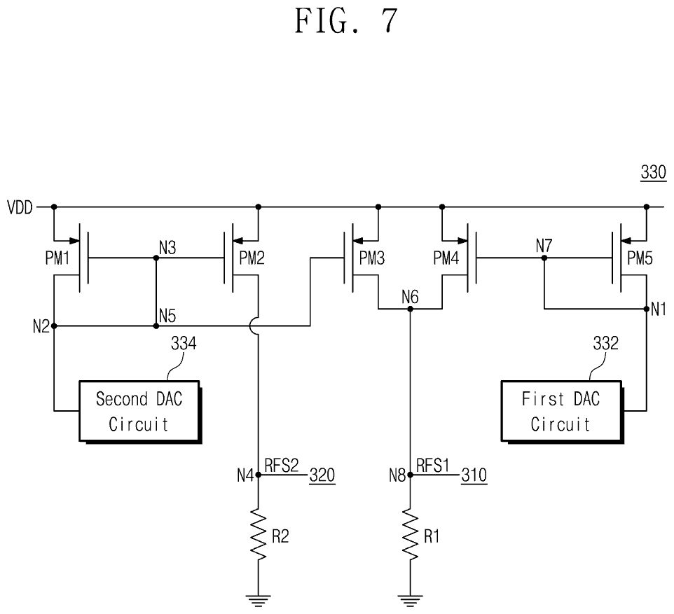

The comparison reference signal generation circuit 330 may provide the generated comparison reference signals RFS1 and RFS2 to the respectively corresponding comparison circuits 310 and 320. In an embodiment, the digital data used for the comparison reference signal generation circuit 330 to generate the comparison reference signals RFS1 and RFS2 may be data for restoring a magnitude (or sensitivity) of the receive signal VRX. The comparison reference signal generation circuit 330 will be described in detail with reference to FIGS. 6 and 7.

The sampling clock generation circuit 340 may generate a clock signal CLK required for a sampling operation. In an embodiment, the sampling clock generation circuit 340 may generate the clock signal CLK in response to a delay signal DS. The sampling clock generation circuit 340 may operate to be the same as or similar to a sampling clock generation circuit 220 of FIG. 3. In an embodiment, the sampling clock generation circuit 340 may generate the clock signal CLK with a period which is the same as or shorter than a period of a pulse repeatedly generated by a transmitter 120 of FIG. 2.

The sampling accumulating circuit 350 may accumulate the comparison signals CS1 and CS2 received from the comparison circuits 310 and 320. The sampling accumulating circuit 350 may operate to be the same as or similar to a sampling accumulating circuit 230 of FIG. 3. In an embodiment, the sampling accumulating circuit 350 may operate, in response to the clock signal CLK. For example, the sampling accumulating circuit 350 may accumulate the first comparison signal CS1 and the second comparison signal CS2, in response to the clock signal CLK received from the sampling clock generation circuit 340. The sampling accumulating circuit 350 may deliver the accumulated comparison signals CS1 and CS2 to an accumulating module 145 of FIG. 2.

The high-speed sampling module 300 described with reference to FIG. 5 may perform a sampling operation for intensity of the receive signal VRX at a faster speed than a high-speed sampling module (e.g., a high-speed sampling module 200 of FIG. 3) for performing a sampling operation using only one comparison circuit. The high-speed sampling module 300 of FIG. 5 may decrease a sampling time of the receive signal VRX to about half of a sampling time of a receive signal VRX of the high-speed sampling module 200 of FIG. 3, without an excessive increase in circuit area and an excessive increase in power consumption.

FIG. 6 is a block diagram illustrating in detail a comparison reference signal generation circuit of FIG. 5, according to an embodiment of the present disclosure. Referring to FIG. 6, a comparison reference signal generation circuit 330 may include a first digital-to-analog conversion (DAC) circuit 331, a second DAC circuit 333, a third DAC circuit 335, and a summation circuit 337. The comparison reference signal generation circuit 330 according to an embodiment of the present disclosure will be described with reference to FIG. 6.

Referring to FIG. 5 together, the first DAC circuit 331 may convert digital data into an analog signal. In an embodiment, the first DAC circuit 331 may receive a constant digital input CDI to generate an analog signal corresponding to a magnitude of the constant digital input CDI. In an embodiment, the constant digital input CDI may correspond to a value of an MSB of digital data for restoring a magnitude (or sensitivity) of a receive signal VRX. For example, the first DAC 331 may generate an analog signal corresponding to the magnitude of digital data, the MSB of which is logic 1 and the remaining bits of which are logic 0.

The second DAC circuit 333 may convert digital data into an analog signal. In an embodiment, the second DAC circuit 333 may receive a varying digital input VDI to generate an analog signal corresponding to a magnitude of the varying digital input VDI. In an embodiment, the second DAC circuit 333 may generate an analog signal corresponding to a value of bits except for the MSB of the digital data for restoring the magnitude (or sensitivity) of the receive signal VRX.

The varying digital input VDI may be a portion of the digital data for restoring the magnitude of the receive signal VRX. in an embodiment, the varying digital input VDI may vary in magnitude at a certain period or at random intervals (or at a random period). For example, the varying digital input VDI may be a value of the remaining bits except for the MSB of the digital data. For a more detailed example, when the digital data for restoring the magnitude of the receive signal is 12 bits, the varying digital input VDI may be 11-bit digital data except for the MSB.

In an embodiment, the varying digital input VDI may sequentially increase in magnitude. For example, the varying digital input VDI may sequentially increase by a value of logic 1 of a least significant bit (LSB). For example, when the digital data has a 12-bit length, the varying digital input VDI may sequentially increase and change from “00000000001” to “11111111111” by logic 1.

In an embodiment, the analog signal generated by the second DAC circuit 333 may be the same as or similar to a second comparison reference signal RFS2 of FIG. 4B. For example, the analog signal generated by the second DAC circuit 333 may be the same as the second comparison reference signal RFS2 of FIG. 4B. For another example, the analog signal generated by the second DAC circuit 333 may be the same as a signal obtained by subtracting an initial voltage level V0 from the second comparison reference signal RFS2 of FIG. 4B. The second DAC circuit 333 may provide the summation circuit 337 with the generated analog signal. For example, the second DAC circuit 333 may provide the summation circuit 337 with the analog signal generated by converting the varying digital input VDI.

The third DAC circuit 335 may convert digital data into an analog signal. In an embodiment, the third DAC circuit 335 may receive the varying digital input VDI to generate an analog signal corresponding to a magnitude of the varying digital input VDI. The third DAC circuit 335 may be the same as or similar to the second DAC circuit 333.

In an embodiment, the analog signal generated by converting the varying digital input VDI by the third DAC circuit 335 may be the second comparison reference signal RFS2. The third DAC circuit 335 may deliver the generated analog signal to a second comparison circuit 320. For example, the third DAC circuit 335 may receive the varying digital input VDI and may deliver the generated second comparison reference signal RFS2 to the second comparison circuit 320.

Outputs of the second DAC circuit 333 and the third DAC circuit 335 may be the same as each other. In an embodiment, one of the second DAC circuit 333 and the third DAC circuit 335 may fail to be included in the comparison reference signal generation circuit 330. For example, the comparison reference signal generation circuit 330 may fail to include the third DAC circuit 335. In this case, the second DAC circuit 333 may provide the summation circuit 337 with an analog signal corresponding to the varying digital input VDI and may simultaneously provide the second comparison circuit 320 with the second comparison reference signal RFS2.

The summation circuit 337 may sum the received inputs and may provide an output. In an embodiment, the summation circuit 337 may sum voltages of the received inputs to generate the output. For example, the summation circuit 337 may sum the voltages of the output of the first DAC circuit 331 and the output of the second DAC circuit 333 to generate the output. In an embodiment, the summation circuit 337 may include a circuit of a structure for summing voltages or signals. For example, the summation circuit 337 may include a voltage summer configured to sum voltages of inputs.

The summation circuit 337 may generate a first comparison reference signal RFS1, based on the received inputs. For example, the summation circuit 337 may sum the output signal of the second DAC circuit 333, which varies in size depending on a change in the varying digital input VDI to the fixed output signal of the first DAC circuit 331 to generate the first comparison reference signal RFS1. The summation circuit 337 may provide a first comparison circuit 310 with the generated first comparison reference signal RFS1.

FIG. 7 is a circuit diagram illustrating in detail a comparison reference signal generation circuit of FIG. 5, according to an embodiment of the present disclosure. Referring to FIG. 7, a comparison reference signal generation circuit 330 may include a first p-type metal-oxide-semiconductor (PMOS) transistor PM1, a second PMOS transistor PM2, a third PMOS transistor PM3, a fourth PMOS transistor PM4, a fifth PMOS transistor PM5, a first resistor R1, a second resistor R2, a first DAC circuit 332, and a second DAC circuit 334.

The first DAC circuit 332 may convert a portion of digital data for restoring a magnitude (or sensitivity) of a receive signal VRX of FIG. 5 into an analog signal. Referring to FIG. 7, the first DAC circuit 332 may be connected with a first node N1. For example, the first DAC circuit 332 may generate an analog current signal which flows in the direction of the first DAC circuit 332 from the first node N1.

In an embodiment, the first DAC circuit 332 may output an analog signal in the form of current corresponding to fixed digital data. For example, the first DAC circuit 332 may generate an analog current corresponding to that a digit of an MSB of the digital data for restoring a magnitude (or sensitivity) of a receive signal VRX is logic 1. For a more detailed example, the first DAC circuit 332 may generate a current signal in an analog form corresponding to a constant digital input CDI of FIG. 6.

The second DAC circuit 334 may convert a portion of the digital data for restoring the magnitude (or sensitivity) of the receive signal VRX of FIG. 5 into an analog signal. Referring to FIG. 7, the second DAC circuit 334 may be connected with a second node N2. For example, the second DAC circuit 334 may generate an analog current signal which flows in the direction of the second DAC circuit 334 from the second node N2.

In an embodiment, the second DAC circuit 334 may output an analog signal in the form of current corresponding to digital data which changes over time. For example, the second DAC circuit 334 may generate an analog current corresponding to data corresponding to the remaining portion except for the MSB of the digital data for restoring the magnitude (or sensitivity) of the receive signal VRX. For a more detailed example, the second DAC circuit 334 may generate a current signal in an analog form corresponding to a varying digital input VDI of FIG. 6.

The first PMOS transistor PM1 may be connected between a power node and the second node N2. A gate node of the first PMOS transistor PM1 may be connected with a third node N3. The second PMOS transistor PM2 may be connected between the power node and a fourth node N4. The fourth node N4 may output a second comparison reference signal RFS2. A gate node of the second PMOS transistor PM2 may be connected with the third node N3. The third node N3 may be connected with the second node N2 via a fifth node N5. The second resistor R2 may be connected between the fourth node N4 and a ground node.

The third PMOS transistor PM3 may be connected between the power node and a sixth node N6. A gate node of the third PMOS transistor PM3 may be connected with the fifth node N5. The fourth PMOS transistor PM4 may be connected with the power node and the sixth node N6. A gate node of the fourth PMOS transistor PM4 may be connected with a seventh node N7. The sixth node N6 may be connected with an eighth node N8 for outputting a first comparison reference signal RFS1.

The fifth PMOS transistor PM5 may be connected between the power node and the first node N1. A gate node of the fifth PMOS transistor PM5 may be connected with the seventh node N7. The seventh node N7 may be connected with the first node N1. The first resistor R1 may be connected between the eighth node N8 and the ground node.

The PMOS transistors PM1, PM2, PM3, PM4, and PM5 of FIG. 7 may generate a current mirror based on the connected structure. A current by the first DAC circuit 332 may flow in the fifth PMOS transistor PM5. A current in the fifth PMOS transistor PM5 may flow in the fourth PMOS transistor PM4, based on the above-described connection relationship. Likewise, a current by the second DAC circuit 334 may flow in the first PMOS transistor PM1. A current in the first PMOS transistor PM1 may flow in the second PMOS transistor PM2 and the third PMOS transistor PM3, based on the above-described connection relationship.

A current which flows in the second resistor R2 may be a current generated by the second DAC circuit 334, depending on the structure of the current mirror. A current which flows in the first resistor R1 may be the sum of a current generated by the first DAC circuit 332, which is supplied via the sixth node N6, and a current generated by the second DAC circuit 334. Referring to FIG. 4 together, the first comparison reference signal RFS1 generated through the second resistor R2 may be the same as or similar to a second comparison reference signal RFS2 of FIG. 4B. Likewise, the first comparison reference signal RFS1 generated through the first resistor R1 may be the same as or similar to a first comparison reference signal RFS1 of FIG. 4B.

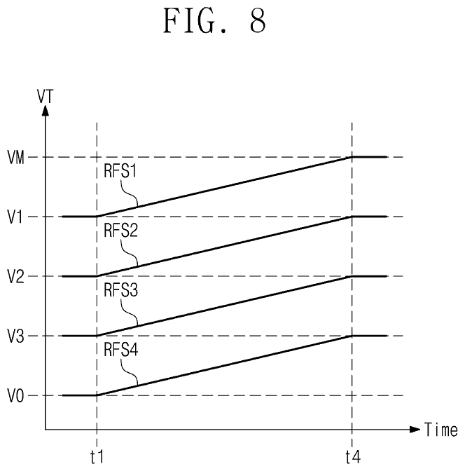

FIG. 8 is a graph illustrating comparison reference signals, according to an embodiment according the present disclosure. Referring to FIG. 8, the horizontal axis may indicate time, and the vertical axis may indicate the magnitude of the voltage VT. Referring to FIG. 8, changes in voltage of each of a first comparison reference signal RFS1, a second comparison reference signal RFS2, a third comparison reference signal RFS3, and a fourth comparison reference signal RFS4 over time are illustrated.

Referring to FIG. 8, start voltages of the comparison reference signals RFS1, RFS2, RFS3, and RFS4 may be different from each other. For example, the start voltage of the first comparison reference signal RFS1 may be a first voltage level V1 and the start voltage of the third comparison reference signal RFS3 may be a third voltage level V3. Likewise, the start voltage of the fourth comparison reference signal RFS4 may be an initial voltage level V0. In an embodiment, the first voltage level V1, the second voltage level V2, and the third voltage level V3 may be voltages between the initial voltage level V0 and a maximum voltage level VM.

Like a comparison reference signal RFS of FIG. 4A and a first comparison reference signal RFS1 and a second comparison reference signal RFS2 of FIG. 4B, the comparison reference signals RFS1, RFS2, RFS3, and RFS4 may sequentially increase. For example, the first comparison reference signal RFS1 may increase from the first voltage level V1 to the maximum voltage level VM and the second comparison reference signal RFS2 may increase from the second voltage level V2 to the first voltage level V1. Likewise, the third comparison reference signal RFS3 may increase from the third voltage level V3 to the second voltage level V2 and the fourth comparison reference signal RFS4 may increase from the initial voltage level V0 to the third voltage level V3.

In an embodiment, all of intervals between the voltages V0, V1, V2, V3, and VM may be the same as each other. For example, the first voltage level V1 may be ¾ of the maximum voltage level VM and the third voltage level V3 may be ¼ of the maximum voltage level VM. In an embodiment, the initial voltage level V0 may be an offset voltage for analog conversion of digital data. In an embodiment, an interval between the voltages V1, V2, V3, and VM may correspond to a value corresponding to a digit of an upper second bit of digital data for restoring a magnitude (or sensitivity) of a receive signal VRX. For example, most significant two bits of the digital data, which correspond to the first voltage level V1, may be logic 11 and most significant two bits of the digital data, which correspond to the second voltage level V2, may be logic 10. Likewise, most significant two bits of the digital data, which correspond to the third voltage level V3, may be logic 01 and most significant two bits of the digital data, which correspond to the initial voltage level V0, may be logic 00.

In an embodiment, the comparison reference signals RFS1, RFS2, RFS3, and RFS4 may sequentially increase in voltage until first to fourth time points t1 to t4. Herein, a time between the first time point t1 and the fourth time point t4 may be a sampling time of a high-speed sampling module 143 of FIG. 2. Referring to FIGS. 4A, 4B, and 8 together, the sampling speed in FIG. 8 may be 4 times the sampling speed of FIG. 4A. In other words, the sampling time may be shortened using the four comparison reference signals. In an embodiment, a time between the first time point t1 and the fourth time point t4 may be ¼ times the time between the first time point t1 and the second time point t2 of FIG. 4A. Alternatively, in an embodiment, the time between the first time point t1 and the fourth time point t4 may be greater than or equal to ¼ times the time between the first time point t1 and the second time point t2 of FIG. 4A and may be less than ½ times the time between the first time point t1 and the second time point t2.

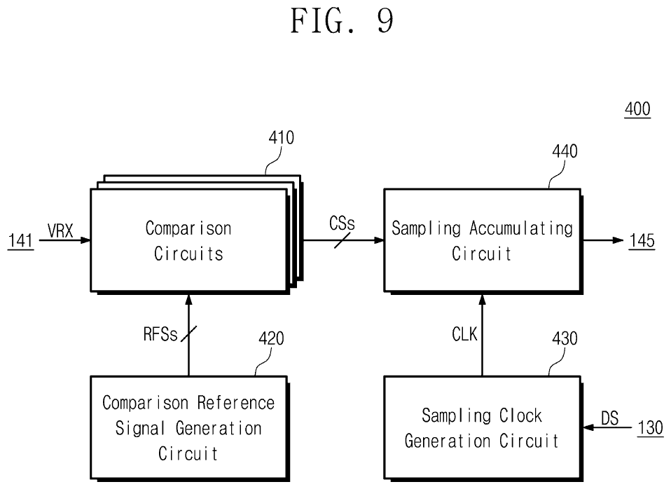

FIG. 9 is a block diagram illustrating a high-speed sampling module, according to an embodiment of the present disclosure. A high-speed sampling module 400 of FIG. 9 may correspond to a high-speed sampling module 143 of FIG. 2. Referring to FIG. 9, the high-speed sampling module 400 may include comparison circuits 410, a comparison reference signal generation circuit 420, a sampling clock generation circuit 430, and a sampling accumulating circuit 440. A description will be given of the high-speed sampling module 400 for providing high-speed sampling with reference to FIG. 9.

The comparison circuits 410 may perform comparison operations between a receive signal VRX generated by a low-noise amplifying module 141 of FIG. 2 and comparison reference signals RFSs. The comparison circuits 410 may operate to be the same as or similar to a comparison circuit 210 of FIG. 3, a first comparison circuit 310 of FIG. 5, or a second comparison circuit 320 of FIG. 5. In an embodiment, the comparison reference signals RFSs may be a plurality of signals.

The comparison circuits 410 may include individual comparison circuits which are the same as the number of the comparison reference signals RFSs. For example, when the comparison reference signals RFSs are comparison reference signals RFS1, RFS2, RFS3, and RFS4 of FIG. 8, the comparison circuits 410 may include four individual comparison circuits.

The comparison circuits 410 may output comparison signals CSs in the form of 1 bit, respectively. For example, the comparison circuits 410 may output results of comparison between corresponding comparison reference signals RFSs and the receive signal VRX. In an embodiment, each of the comparison circuits 410 may deliver the compared result to the sampling accumulating circuit 440. For example, when the receive signal VRX is greater in voltage than corresponding comparison reference signals RFSs, each of the comparison circuits 410 may generate logic 1 as an output. The comparison circuits 410 may deliver the generated comparison signals CSs to the sampling accumulating circuit 440.

In an embodiment, until the comparison circuits 410 compare the receive signal VRX with all the voltages in the comparison reference signals RFSs, a radar device 10 of FIG. 1 may scan the same detection target. In other words, the comparison circuits 410 may compare the same receive signal VRX with all the voltages (corresponding to comparison signals in a digital form) in the comparison reference signals RFSs and may deliver comparison signals CSs corresponding to the results of comparing the receive signal VRX with the respective voltages to the sampling accumulating circuit 440. The comparison circuits 410 may restore a magnitude of an echo pulse received via the receive antenna RX, based on the above-mentioned operation.

The comparison reference signal generation circuit 420 may generate the comparison reference signals RFSs provided to the comparison circuits 410. In an embodiment, the comparison reference signal generation circuit 420 may convert digital data into an analog signal to generate the comparison reference signals RFSs. For example, the comparison reference signal generation circuit 420 may convert digital data to generate comparison reference signals RFS1, RFS2, RFS3, and RFS4 of FIG. 8.

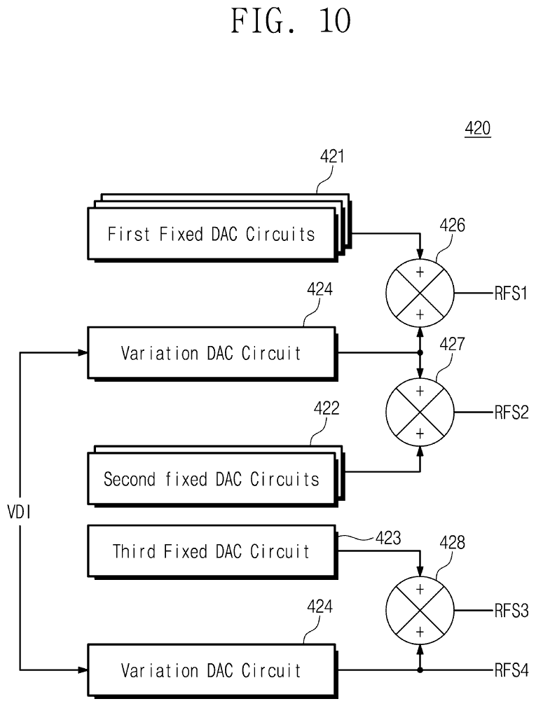

The comparison reference signal generation circuit 420 may provide the generated comparison reference signals RFSs to the respectively corresponding comparison circuits 410. In an embodiment, the digital data used for the comparison reference signal generation circuit 420 to generate the comparison reference signals RFSs may be digital data for restoring a magnitude (or sensitivity) of the receive signal VRX. The comparison reference signal generation circuit 420 will be described in detail with reference to FIG. 10.

The sampling clock generation circuit 430 may generate a clock signal CLK required for a sampling operation. In an embodiment, the sampling clock generation circuit 430 may generate the clock signal CLK in response to a delay signal DS. The sampling clock generation circuit 430 may operate to be the same as or similar to a sampling clock generation circuit 220 of FIG. 3 or a sampling clock generation circuit 340 of FIG. 5. In an embodiment, the sampling clock generation circuit 430 may generate the clock signal CLK with a period which is the same as or shorter than a period of a pulse repeatedly generated by a transmitter 120 of FIG. 2.

The sampling accumulating circuit 440 may accumulate the comparison signals CSs received from the comparison circuits 410. The sampling accumulating circuit 440 may operate to be the same as or similar to a sampling accumulating circuit 230 of FIG. 3 or a sampling accumulating circuit 350 of FIG. 5. In an embodiment, the sampling accumulating circuit 440 may operate, in response to the clock signal CLK. For example, the sampling accumulating circuit 440 may accumulate the comparison signals CSs, in response to the clock signal CLK generated from the sampling clock generation circuit 430. The sampling accumulating circuit 440 may deliver the accumulated signals CSs to an accumulating module 145 of FIG. 2.

The high-speed sampling module 400 described with reference to FIG. 9 may perform a sampling operation for intensity of the receive signal VRX at a faster speed than a high-speed sampling module (e.g., a high-speed sampling module 200 of FIG. 3) for performing a sampling operation using only one comparison circuit. Furthermore, the high-speed sampling module 400 described with reference to FIG. 9 may perform a sampling operation for intensity of the receive signal VRX at a faster speed than a high-speed sampling module (e.g., the high-speed sampling module 200 of FIG. 3) for performing a sampling operation using only two comparison circuits. The high-speed sampling module 400 of FIG. 9 may considerably decrease a sampling time, without an excessive increase in circuit area and an excessive increase in power consumption.

FIG. 10 is a block diagram illustrating a comparison reference signal generation circuit of FIG. 8 or 9, according to an embodiment of the present disclosure. Referring to FIG. 10, a comparison reference signal generation circuit 420 may include first fixed DAC circuits 421, second fixed DAC circuits 422, a third fixed DAC circuit 423, a variation DAC circuit 424, a first summation circuit 426, a second summation circuit 427, and a third summation circuit 428.

Referring to FIGS. 8 and 9 together, the first fixed DAC circuit 421 may convert digital data into an analog signal. In an embodiment, the first fixed DAC circuit 421 may convert fixed digital data into an analog signal. For example, the first fixed DAC circuit 421 may generate an analog signal corresponding to the size of data in which a value of most significant two bits of digital data for restoring the magnitude (or sensitivity) of a receive signal VRX is logic 11 and a value of the remaining bits is logic 0. For a more detailed example, the first fixed DAC circuit 421 may generate a first voltage level V1 of FIG. 8 (or a voltage in which an initial voltage level V0 is excluded from the first voltage level V1). The first fixed DAC circuit 421 may deliver the generated analog signal to the first summation circuit 426.

The second fixed DAC circuit 422 may convert digital data into an analog signal. In an embodiment, the second fixed DAC circuit 422 may convert fixed digital data into an analog signal. For example, the second fixed DAC circuit 422 may generate an analog signal corresponding to the size of data in which a value of most significant two bits of digital data for restoring the magnitude (or sensitivity) of the receive signal VRX is logic 10 and a value of the remaining bits is logic 0. For a more detailed example, the second fixed DAC circuit 422 may generate a second voltage level V2 of FIG. 8 (or a voltage in which the initial voltage level V0 is excluded from the second voltage level V2). The second fixed DAC circuit 422 may deliver the generated analog signal to the second summation circuit 427.

The third fixed DAC circuit 423 may convert digital data into an analog signal. In an embodiment, the third fixed DAC circuit 423 may convert fixed digital data into an analog signal. For example, the third fixed DAC circuit 423 may generate an analog signal corresponding to the size of data in which a value of most significant two bits of digital data for restoring the magnitude (or sensitivity) of the receive signal VRX is logic 01 and a value of the remaining bits is logic 0. For a more detailed example, the third fixed DAC circuit 423 may generate a third voltage level V3 of FIG. 8 (or a voltage in which the initial voltage level V0 is excluded from the third voltage level V3). The third fixed DAC circuit 423 may deliver the generated analog signal to the third summation circuit 428.

The variation DAC circuit 424 may convert digital data into an analog signal. In an embodiment, the second DAC circuit 333 may receive a varying digital input VDI to generate an analog signal corresponding to the magnitude of the varying digital input VDI. In an embodiment, the variation DAC circuit 424 may generate an analog signal corresponding to a value of bits except for the most significant two bits of the digital data for restoring the magnitude (or sensitivity) of the receive signal VRX.

The varying digital input VDI may be a portion of the digital data for restoring the magnitude of the receive signal VRX. In an embodiment, the varying digital input VDI may vary in magnitude at a certain period or at random intervals (or at a random period). For example, the varying digital input VDI may be a value of the remaining bits except for the most significant two bits of the digital data. For a more detailed example, when the digital data for restoring the magnitude of the receive signal is 12 bits, the varying digital input VDI may be 11-bit digital data except for the MSB.

In an embodiment, the varying digital input VDI may sequentially increase in magnitude. For example, the varying digital input VDI may sequentially increase by a value of logic 1 of a least significant bit (LSB). For example, when the digital data has a 12-bit length, the varying digital input VDI may sequentially increase and change from “0000000001” to “1111111111” by logic 1.

In an embodiment, the analog signal generated by the variation DAC circuit 424 may be the same as or similar to a fourth comparison reference signal RFS4 of FIG. 8. For example, referring to FIG. 10, the analog signal generating by the variation DAC circuit 424 may be the same as the fourth comparison reference signal RFS4 of FIG. 8. For another example, the analog signal generating by the variation DAC circuit 424 may be a signal in which the initial voltage level V0 is excluded from the fourth comparison reference signal RFS4 of FIG. 8. The variation DAC circuit 424 may provide the first summation circuit 426, the second summation circuit 427, and the third summation circuit 428 with the output signal.

The summation circuits 426, 427, and 428 may sum the received inputs and may provide outputs. In an embodiment, the summation circuit 426, 427, and 428 may sum voltages of the received inputs to generate the outputs. For example, the first summation circuit 426 may sum the voltages of the output of the first fixed DAC circuit 421 and the output of the variation DAC circuit 424 to generate the output (i.e., a first comparison reference signal RFS1). In an embodiment, each of the summation circuits 426, 427, and 428 may include a circuit of a structure for summing voltages or signals. For example, each of the summation circuits 426, 427, and 428 may include a voltage summer configured to sum voltages of inputs.

The comparison reference signal generation module 400 for generating the four comparison reference signals is described in FIG. 10, but the scope of the present disclosure is not limited thereto. It should be understood that a comparison reference signal generation circuit for generating five or more comparison reference signals depending on an operation form of a high-speed sampling module 143 of FIG. 2 or the like also belongs to the scope of the present disclosure.

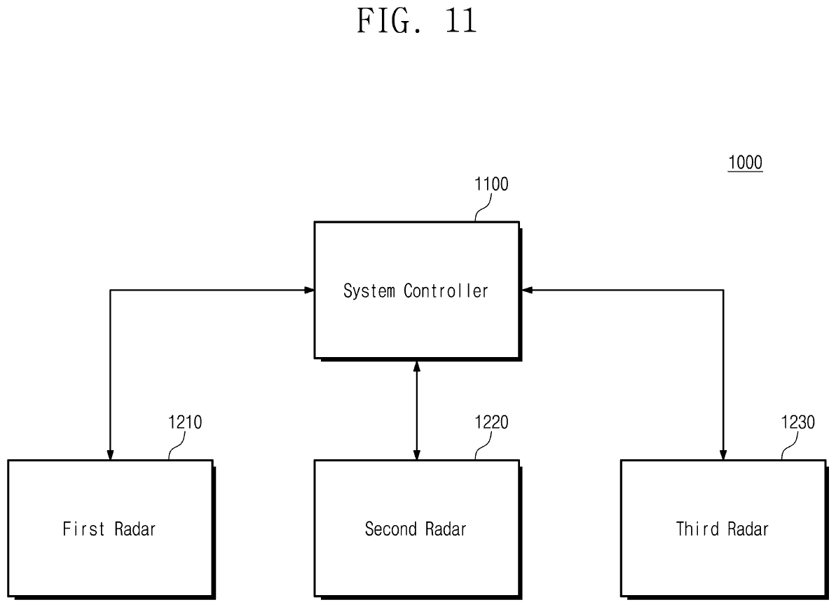

FIG. 11 is a block diagram illustrating a radar system, according to an embodiment of the present disclosure. Referring to FIG. 11, a radar system 1000 may include a system controller 1100, a first radar 1210, a second radar 1220, and a third radar 1230.

The system controller 1100 may control a plurality of radars. For example, the system controller 1100 may control the first radar 1210, the second radar 1220, or the third radar 1230. In an embodiment, the system controller 1100 may control radars to detect the same detection target.

In an embodiment, the system controller 1100 may control at least some of radars to detect different detection targets. For example, the system controller 1100 may control the first radar 1210 and the second radar 1220 to detect a first detection target and may control the third radar 1230 to detect a second detection target. In an embodiment, the system controller 1100 may control all the radars to detect different detection targets. For example, the system controller 1100 may control the first radar 1210 to detect the first detection target, may control the second radar 1220 to detect the second detection target, and may control the third radar 1230 to detect a third detection target.

The system controller 1100 may receive the detected results from the radars. For example, the system controller 1100 may receive the detected result from the first radar 1210, the second radar 1220, or the third radar 1230. In an embodiment, the system controller 1100 may visually or audibly display the detected results received from the radars. In an embodiment, the system controller 1100 may transmit the received detected results to at least one external device. In an embodiment, the system controller 1100 may receive a control signal from the at least one external device and may control the radars, based on the control signal.

The first radar 1210, the second radar 1220, and the third radar 1230 may detect the same detection target or different detection targets. Each of the first radar 1210, the second radar 1220, and the third radar 1230 may be configured or operate, depending on the embodiments described with reference to FIGS. 1 to 10. The three radars are illustrated in FIG. 11, and this is illustrative. The scope of the present disclosure is not limited thereto. It should be understood that an embodiment in which the radar system 1000 include more radars than the radars shown in FIG. 11 or an embodiment in which the radar system 1000 further includes at least one system controller also belongs to the scope of the present disclosure.

According to an embodiment of the present disclosure, the radar device including a transceiver capable of sampling a receive pulse at a high speed may be provided.

The above-mentioned contents are detailed embodiments for executing the present disclosure. The present disclosure may include embodiments capable of being simply changed in design or being easily changed, as well as the above-mentioned embodiments. In addition, technologies that are easily changed and implemented by using the embodiments may be included in the present disclosure. Therefore, the spirit and scope of the present disclosure is defined not by the above-described embodiments, but by those that are identical or equivalent to the claims of the present disclosure as well as the appended claims, which will be described below.

What is claimed is:

1. A radar device configured to detect a detection target, the radar device comprising:
a receiver configured to receive an echo pulse reflected from the detection target; and
a radar control block configured to control the radar device,
wherein the receiver includes:
a low-noise amplifying module configured to amplify the echo pulse; and
a high-speed sampling module configured to sample a receive signal generated as the low-noise amplifying module amplifies the echo pulse,
wherein the high-speed sampling module includes:
a comparison reference signal generation circuit configured to generate comparison reference signals, wherein the comparison reference signals include a first comparison reference signal and a second comparison reference signal;
a first comparison circuit configured to compare the receive signal with the first comparison reference signal to generate a first comparison signal; and
a second comparison circuit configured to compare the receive signal with the second comparison reference signal to generate a second comparison signal, and
wherein the first comparison reference signal is greater in level than the second comparison reference signal.

2. The radar device of claim 1, further comprising:
a pulse transceiver block configured to include the receiver and include a transmitter for radiating a transmit pulse; and
a communication block configured to communicate with an external device.

3. The radar device of claim 2, wherein the pulse transceiver block further includes a delayer configured to generate a delay signal corresponding to the transmit pulse, and
wherein the transmitter includes:
a pulse generation module configured to generate a transmit basis pulse which is the basis of the transmit pulse; and
a pulse amplification module configured to amplify the transmit basis pulse to generate the transmit pulse.

4. The radar device of claim 2, wherein the pulse transceiver block further includes a processor configured to control the transmitter and the receiver and receive data for the detection target from the receiver.

5. The radar device of claim 3, wherein the high-speed sampling module operates in response to the delay signal, and
wherein the high-speed sampling module further includes:
a sampling clock generation circuit configured to generate a clock signal in response to the delay signal; and
a sampling accumulating circuit configured to receive the clock signal and accumulate comparison signals including the first comparison signal and the second comparison signal.

6. The radar device of claim 5, wherein the comparison reference signals are generated by converting digital data for restoring the echo pulse into an analog signal.

7. The radar device of claim 6, wherein each of the comparison reference signals increases by a corresponding voltage level, as the corresponding digital data sequentially increases by logic 1.

8. The radar device of claim 7, wherein the first comparison reference signal sequentially increases from a first voltage level to a maximum voltage level,
wherein the second comparison reference signal sequentially increases from an initial voltage level to the first voltage level, and
wherein the maximum voltage level corresponds to a maximum value of the digital data and the initial voltage level corresponds to a minimum value of the digital data.

9. The radar device of claim 7, wherein the comparison reference signals further include a third comparison reference signal and a fourth comparison reference signal.

10. The radar device of claim 7, wherein the comparison reference signal generation circuit includes:
a first digital-to-analog conversion (DAC) circuit configured to generate a first analog signal corresponding to that a most significant bit of the digital data is logic 1 and the remaining bits are logic 0;
a second DAC circuit configured to generate a second analog signal corresponding to a varying digital input which is the remaining bits except for the most significant bit of the digital data; and
a summation circuit configured to sum the first analog signal and the second analog signal to generate a third analog signal,
wherein the varying digital input sequentially increases by logic 1, and
wherein the second analog signal is the second comparison reference signal and the third analog signal is the first comparison reference signal.

11. The radar device of claim 7, wherein the comparison reference signal generation circuit includes:
a first DAC circuit configured to generate a first analog signal corresponding to that a most significant bit of the digital data is logic 1 and the remaining bits are logic 0;
a second DAC circuit configured to generate a second analog signal corresponding to a varying digital input which is the remaining bits except for the most significant bit of the digital data;
a first p-type metal-oxide-semiconductor (PMOS) transistor connected between a first node connected with the first DAC circuit and a power node and having a gate node connected with a second node connected with the first node;
a second PMOS transistor connected between a third node connected with the second DAC circuit and the power node and having a gate node connected with a fourth node;
a third PMOS transistor connected between a fifth node and the power node and having a gate node connected with the fourth node;
a fourth PMOS transistor connected between a sixth node and the power node and having a gate node connected with the third node and the fourth node;
a fifth PMOS transistor connected between the sixth node and the power node and having a gate node connected with the second node;
a first resistor connected between the fifth node and a ground node; and
a second resistor connected between an eighth node connected with the sixth node and the ground node.

12. The radar device of claim 8, wherein the first voltage level is an intermediate value between the initial voltage level and the maximum voltage level.

13. The radar device of claim 9, wherein the first comparison reference signal sequentially increases from a first voltage level to a maximum voltage level,
wherein the second comparison reference signal sequentially increases from a second voltage level lower than the first voltage level to the first voltage level,
wherein the third comparison reference signal sequentially increases from a third voltage level lower than the second voltage level to the second voltage level,
wherein the fourth comparison reference signal sequentially increases from an initial voltage level to the third voltage level,
wherein the maximum voltage level corresponds to a maximum value of the digital data and the initial voltage level corresponds to a minimum value of the digital data, and
wherein the first voltage level, the second voltage level, and the third voltage level are voltage levels between the initial voltage level and the maximum voltage level.

14. The radar device of claim 11, wherein a voltage level of the fifth node is the second comparison reference signal, and
wherein a voltage level of the eighth node is the first comparison reference signal.

15. A radar system configured to detect at least one detection target, the radar system comprising:
a first radar configured to detect the detection target;
a second radar configured to detect the detection target; and
a system controller configured to control the first radar and the second radar,
wherein the first radar includes:
a receiver configured to receive an echo pulse reflected from the detection target and including a high-speed sampling module configured to sample a receive signal generated based on the echo pulse; and
a memory block configured to store the result of detecting the detection target,
wherein the high-speed sampling module includes:
a comparison reference signal generation circuit configured to generate comparison reference signals including a first comparison reference signal and a second comparison reference signal;
a first comparison circuit configured to compare the receive signal with the first comparison reference signal to generate a first comparison signal; and
a second comparison circuit configured to compare the receive signal with the second comparison reference signal, and
wherein the first comparison reference signal is greater in level than the second comparison reference signal.

16. The radar system of claim 15, wherein the comparison reference signals are generated by converting digital data for restoring the echo pulse into an analog signal.

17. The radar system of claim 16, wherein the first comparison reference signal sequentially increases from a first voltage level to a maximum voltage level,
wherein the second comparison reference signal sequentially increases from an initial voltage level to the first voltage level, and
wherein the maximum voltage level corresponds to a maximum value of the digital data and the initial voltage level corresponds to a minimum value of the digital data.
